(19) United States
(12) Patent Application Publication
(10) Pub. No.: US 2003/0197807 A1
(43) Pub. Date: Oct. 23, 2003

(54) LIGHT BULB ADAPTER FOR A CAMERA AND METHOD FOR SAME

(76) Inventor: Vic Chi-Shi Wu, Irvine, CA (US)

Correspondence Address: LAW OFFICE OF GERALD MALISZEWSKI, 11440 WEST BERNARDO COURT, SUITE 157, SAN DIEGO, CA, 92127, US

(21) Appl. No.: 10/124,977

(22) Filed: Apr. 18, 2002

(51) Int. Cl. H04N 5/225

(52) U.S. Cl. 348/375

(57) ABSTRACT

A light bulb adapter camera system and method for same are provided. The system comprises a housing and a data processor having an interface to accept digital image information and an output to supply network formatted digital image information. The system also includes a light bulb compatible screw base for mounting the camera adapter in a light bulb socket and for accepting AC current. A light bulb female socket is typically included to accept a light bulb and to supply AC current, so that the fixture continues to enjoy use as a light bulb fixture, supplying light for the camera. In one aspect of the system the camera is mounted in the housing. A joint between the housing and the screw base is used for rotating and tilting the housing so that the camera-viewing angle can be changed. The system can also interface to microphone and audio speaker interfaces.

### BACKGROUND OF THE INVENTION

1. Field of the Invention

This invention generally relates to digital cameras and, more particularly to a system and method for using a light bulb fixture as a camera adapter and surveillance location.

2. Description of the Related Art

Many security camera are either linked to a recording system or to a network for downloading images from a remote location to a central location. It is popular to use the Internet as the network means. Regardless, the addition of security cameras typically involves the installation of a wiring system for network connections and, even if the camera is wirelessly linked, to a camera power supply. These installation costs must be paid by commercial users who require the service, regardless of cost. The cost of cameras continues to drop, and the popularity of personal computer (PC) multimedia has increased. Further, the Internet has developed as a low cost network medium. As a result, many non-commercial or small business consumers are becoming interested in camera surveillance systems. However, the installation and maintenance costs are still significant cost drivers. For any user, it is expensive to update existing an existing video security system or to easily relocate camera sites once installed.

It would be advantageous if a security camera could be linked to a network without significant camera installation procedures.

It would be advantageous if a security camera could be clandestinely installed at existing power fixtures.

### SUMMARY OF THE INVENTION

The present invention makes the installation of a security camera systems as easy as replacing a light bulb. Installation costs are reduced because of the elimination of power supply and signal wiring. When used with the new powerline networking technology, the present invention system provides high image quality, improved reliability, and increased safety, as compared to conventional systems. The present invention surveillance system permits a user to monitor a video camera either locally on a TV or PC, or remotely through the Internet. The present invention light bulb adapter permits cameras to be easily replaced or viewing angles to be quickly adjusted.

Accordingly, a light bulb adapter camera system is provided. The system comprises a housing and a data processor. The data processor has an interface to accept digital image information and an output to supply network formatted digital image information. The system also includes a light bulb compatible screw base for mounting the camera adapter in a light bulb socket and for accepting AC current. A light bulb female socket is typically included to accept a light bulb and to supply AC current, so that the fixture continues to enjoy use as a light bulb fixture, supplying light for the camera.

In one aspect of the system the camera is mounted in the housing. A joint between the housing and the screw base is used for rotating and tilting the housing so the camera-viewing angle can be changed. In other aspects the camera is mounted on an arm for easy adjustment. The system can also interface to microphone and audio speaker interfaces.

In some aspects, the system further includes a wireless transceiver, and the data processor supplies network formatted digital image information in a wireless communications format to the transceiver. Additionally, the system includes a network wireless transceiver to accept the network formatted digital image information. The system can also include a display device connected to the network transceiver to accept and display the digital image information.

In other aspects, the data processor is a powerline modem having an output connected to the screw base to supply digital image information in a powerline networking format. Then, the system further includes a network powerline modem to accept the digital image information in the powerline network format.

Additional details of the above-described system and a method for forming a light bulb adapter camera system are provided below.

### BRIEF DESCRIPTION OF THE DRAWINGS

FIGS. 1a and 1b depict variations of the present invention light bulb adapter camera system.

FIG. 2 is a schematic block diagram of the present invention light bulb adapter camera system.

FIG. 3 depicts a camera mounting arm variation of the present invention system.

FIGS. 4 and 5 depict some variations of the network powerline modem interfaces.

FIG. 6 is a depiction of a network powerline modem/display combination.

FIG. 7 is a depiction of a combination powerline/wireless aspect of the present invention system.

FIGS. 8a and 8b are flowcharts illustrating the present invention method for forming a light bulb adapter camera system.

### DETAILED DESCRIPTION OF THE PREFERRED EMBODIMENTS

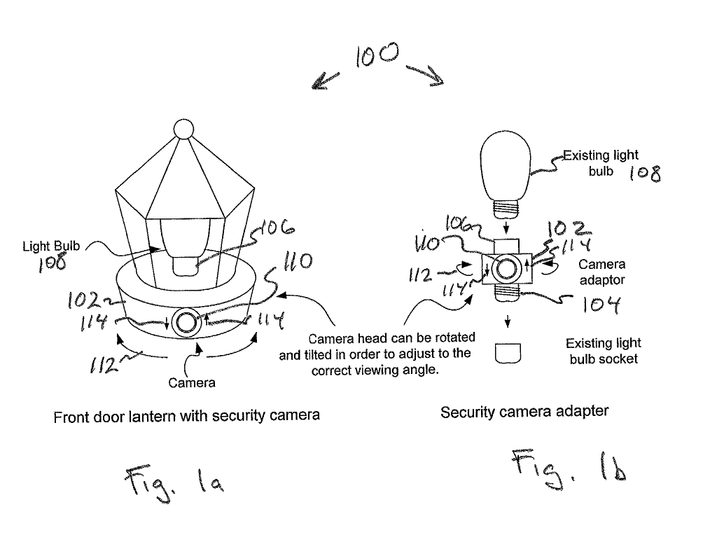

FIGS. 1a and 1b depict variations of the present invention light bulb adapter camera system. FIG. 1a is a front door lantern variation, while FIG. 1b depicts an adapter for a standard lamp. The system 100 comprises a housing 102 and a light bulb compatible screw base 104 (see FIG. 1b) for mounting the camera adapter in a light bulb socket, and for accepting AC current. The system 100 also comprises a light bulb female socket 106 to accept a light bulb 108 and to supply AC current to the light bulb 108. Socket 106 permits a light fixture to be used for its intended purpose, aiding in the clandestine placement of the adapter system 100, and to provide light for a camera.

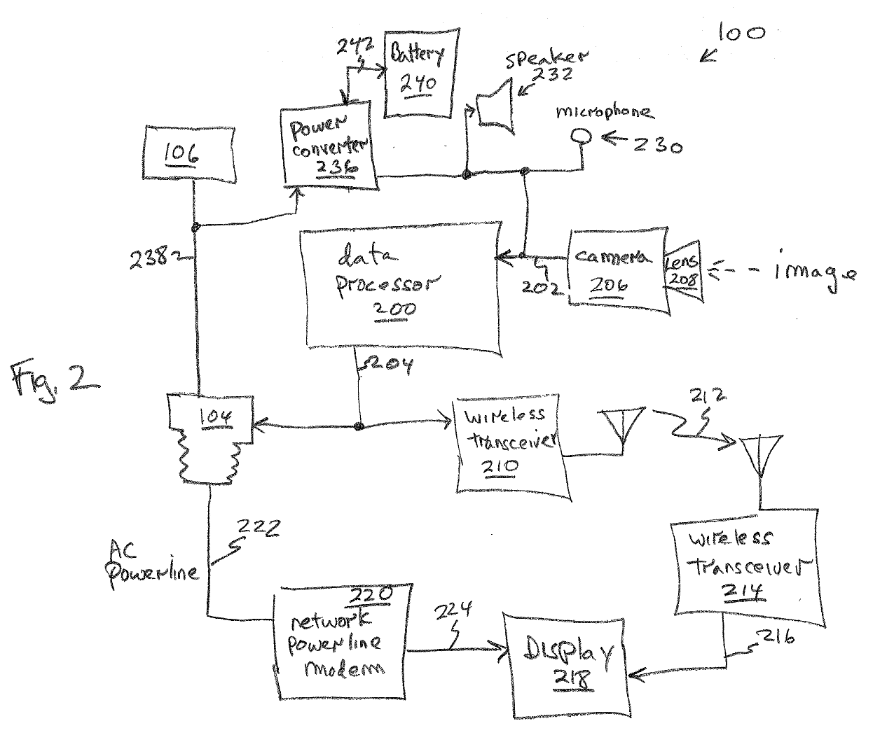

FIG. 2 is a schematic block diagram of the present invention light bulb adapter camera system 100. A first data processor 200 has an interface on line 202 to accept digital image information and an output on line 204 to supply network formatted digital image information. In some aspects of the system 100, a digital camera 206 is mounted to the housing. The camera 206 has a lens 208 to accept images and an output connected to the data processor interface on line 202 to supply digital image information. As shown in FIGS. 1a and 1b, the digital camera can be mounted inside the housing 102, with the housing 102 having an aperture 110 for mounting the camera lens. A joint (not shown) between the housing 102 and the screw base 104 is used for rotating the housing 102 in a first plane, as represented by reference designator 112. The joint also tilts the first plane 112 with respect to the screw base 104, as represented by reference designators 114. Any conventional joint or rotation means can be used to move and rotate the housing (camera lens) with respect to the stationary screw base 104, such as a ball joint interface.

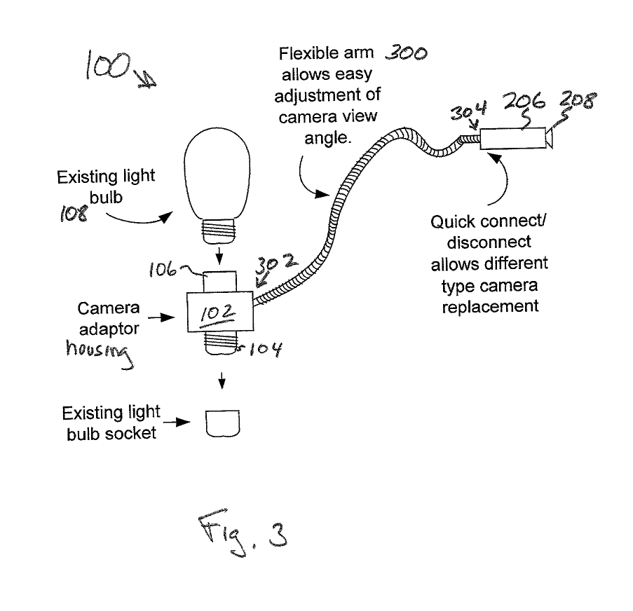

FIG. 3 depicts a camera mounting arm variation of the present invention system 100. A mounting arm 300 has a first end 302 mounted to the housing 102 and electrically connected to the data processor interface (not shown), and a second end 304 mounted to the camera 206 output to accept the digital image information. Typically, the mounting arm 300 is flexible, so that the camera lens 208 can be pointed in response to flexing the mounting arm 300. Again, any conventional technology can be used to enable the flexible mounting arm, such as a flexible plastic or coiled metal. Typically, the mounting arm second end 304 includes a connector (not shown). Then, the digital camera 206 output includes a connector (not shown) for mating to the mounting arm second end connector. Connectors permit the camera to be easily removed and/or replaced.

Returning to FIG. 2, the first data processor supplies network formatted digital image information on line 204 in a wireless communications format in some aspects of the system 100. Then, the system 100 further comprises a first wireless communications transceiver 210 for transceiving the digital image information via an airlink represented by reference designator 212.

In some aspects, the system 100 further comprises a network wireless transceiver 214 having an airlink 212 input to accept the network formatted digital image information from the first wireless communications transceiver 210 and an output on line 216 to supply the digital image information. A display device 218 is connected to the network wireless transceiver on line 216 to accept and display the digital image information.

Alternately, the first data processor 200 is a first powerline modem having an output on line 204 connected to the screw base 104 to supply digital image information in a powerline networking format. Then, the system 100 includes a network powerline modem 220 having an input for connection to AC powerline 222. The network powerline modem 220 accepts the digital image information in the powerline network format and has an output on line 224 to supply digital image information. The display device 218 can be a video monitor or a personal computer having an input connected to the network powerline modem to accept and display the digital image information. The network powerline modem 220 provides the digital image information in a format such as USB, Ethernet, raster data, or a wireless communications format.

Other aspects of the system 100 further comprise a microphone 230 having an output on line 202 connected to the first data processor interface. Then, the first data processor 200 supplies network formatted digital image and audio information. In other aspects, an audio speaker 232 has an input connected to the first data processor interface on line 202 and the first data processor 200 supplies audio information to the speaker 232.

Some aspects of the system 100 further comprise a power converter 236 having an input connected to the screw base 104 to receive AC power on line 238 and an output to supply converted power to a power input of the data processor interface on line 202. A battery 240 can be connected to the power converter 236 to supply power when there is no AC power on line 238, and to receive power replenishment.

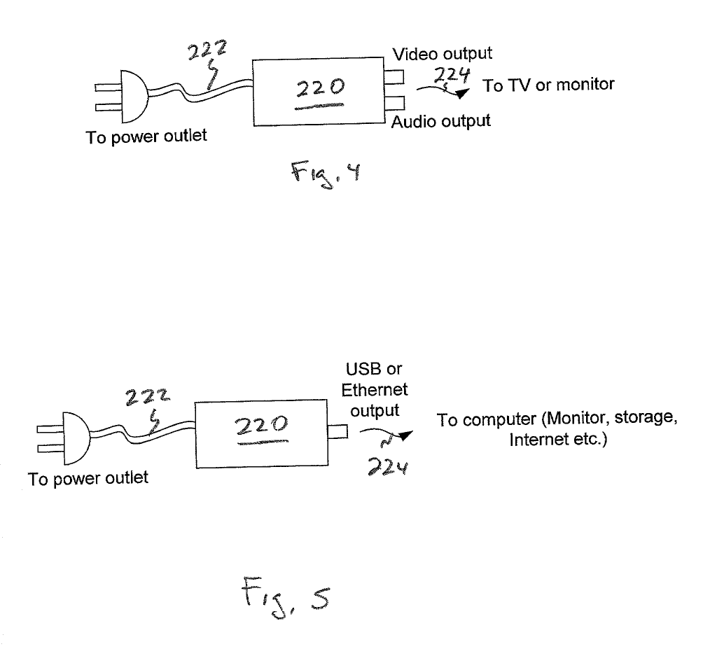

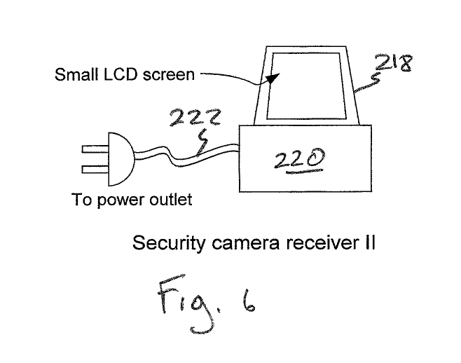

FIGS. 4 and 5 depict some variations of the network powerline modem interfaces. In FIG. 4 the network modem 220 supplies video and audio data to a monitor (not shown) connected on line 224 (see FIG. 2). In FIG. 5 the network modem provides information in a network format for relay over the Internet, intranet, local area network (LAN), or the like, for storage or for remote viewing.

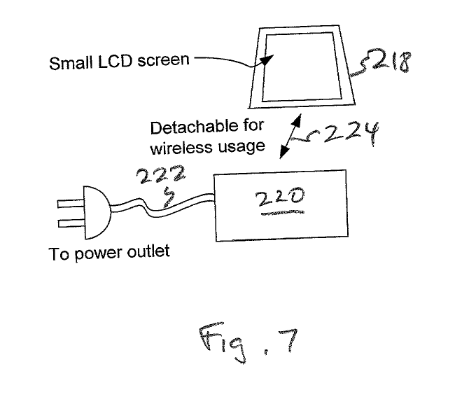

FIG. 6 is a depiction of a network powerline modem/display combination. Here, the network modem 220 and the display 218 are a specialized piece of equipment with the single function of viewing data transmitted by the camera system on line 222.

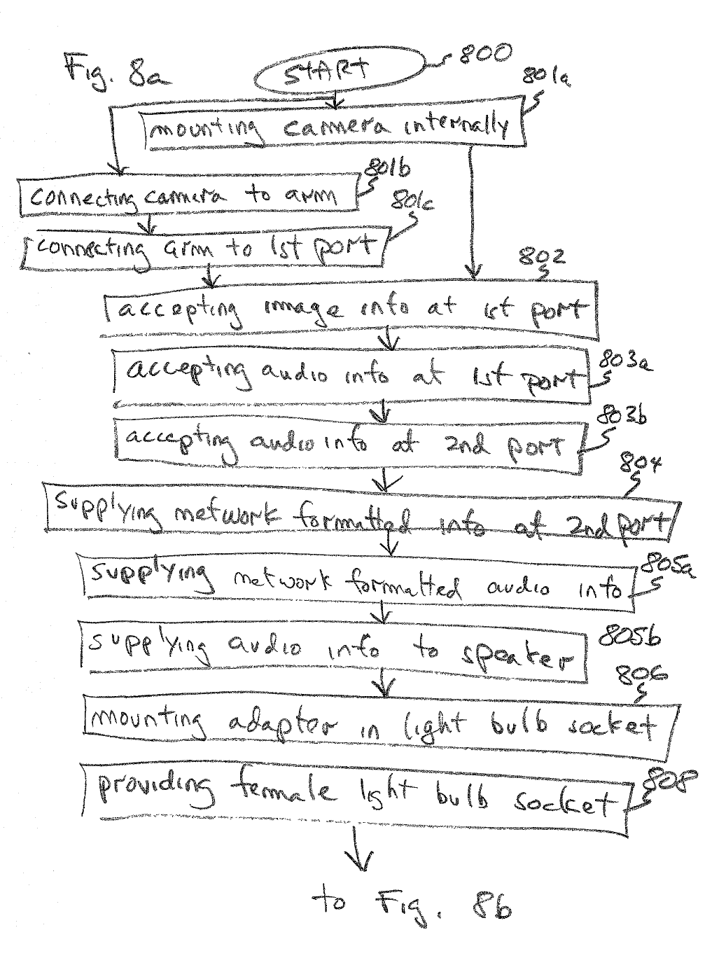

FIG. 7 is a depiction of a combination powerline/wireless aspect of the present invention system. The network powerline modem 220 receives data from the camera system on the AC line 222. The modem also includes a wireless transceiver (not shown) for transmitting the data to the display 218, which also has a wireless transceiver (not shown).

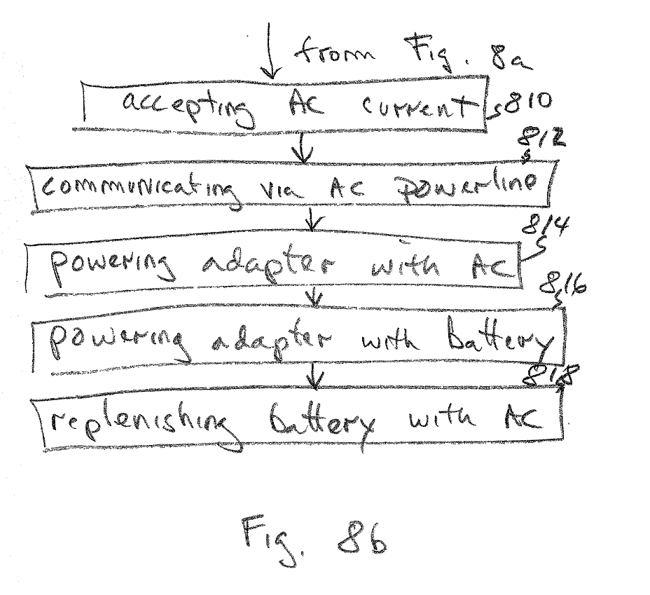

FIGS. 8a and 8b are flowcharts illustrating the present invention method for forming a light bulb adapter camera system. Although this method is depicted as a sequence of numbered steps for clarity, no order should be inferred from the numbering unless explicitly stated. It should be understood that some of these steps may be skipped, performed in parallel, or performed without the requirement of maintaining a strict order of sequence. The methods start at Step 800. Step 802 accepts digital image information at a first adapter port. Step 804 supplies network formatted digital image information from a second adapter port. Step 806 mounts the adapter in a light bulb socket. Step 808 provides a female socket for mounting a light bulb at an adapter third port.

In some aspects of the method a further step, Step 801a, mounts a camera internal to the adapter. Then, accepting digital image information at a first adapter port in Step 802 includes accepting information from the camera. Alternately, Step 801b connects a camera to an arm and Step 801c connects the arm to the adapter first port. As before, accepting digital image information at a first adapter port in Step 802 includes accepting information from the camera, via the arm.

In some aspects, supplying network formatted digital image information from a second adapter port in Step 804 includes communicating network formatted digital image information in a wireless format. Alternately, supplying network formatted digital image information from a second adapter port in Step 804 includes supplying network formatted digital image information in a powerline network format.

In some aspects Step 810 accepts AC current from the light bulb socket. In some aspects, Step 812 communicates powerline network formatted digital image information via the AC current line. Typically, Step 814 powers the adapter using the supplied AC current (Step 810). Step 816 powers the adapter with an internally mounted battery. Step 818 replenishes the battery using the supplied AC current.

In some aspects of the method, Step 803a accepting audio information at the first adapter port. Then, Step 805a supplies network formatted digital audio information from a second adapter port. In other aspects, Step 803b accepts audio information from the adapter second port. Then, Step 805b supplies audio information to a mounted speaker connected to the first adapter port.

A light bulb adapter for a camera, and a method for the same have been provided. A few examples have been given as to how the camera can be housed. However, many other housing arrangements are also practical. Examples have also been given of network communication scenarios. However, the present invention is not limited to just these scenarios. Other variations and embodiments of the invention will occur to those skilled in the art.

We claim:

1. A method for forming a light bulb adapter camera system, the method comprising:
accepting digital image information at a first adapter port;
supplying network formatted digital image information from a second adapter port; and,
mounting the adapter in a light bulb socket.

2. The method of claim 1 further comprising:
providing a female socket for mounting a light bulb at an adapter third port.

3. The method of claim 1 further comprising:
mounting a camera internal to the adapter; and,
wherein accepting digital image information at a first adapter port includes accepting information from the camera.

4. The method of claim 1 further comprising:
connecting a camera to an arm; and,
connecting the arm to the adapter first port; and,
wherein accepting digital image information at a first adapter port in includes accepting information from the camera, via the arm.

5. The method of claim 1 wherein supplying network formatted digital image information from a second adapter port includes communicating network formatted digital image information in a wireless format.

6. The method of claim 1 wherein supplying network formatted digital image information from a second adapter port includes supplying network formatted digital image information in a powerline network format.

7. The method of claim 6 further comprising:
accepting AC current from the light bulb socket.

8. The method of claim 7 further comprising:
communicating powerline network formatted digital image information via the AC current line.

9. The method of claim 7 further comprising;
powering the adapter using the supplied AC current.

10. The method of claim 7 further comprising:
powering the adapter with an internally mounted battery; and,
replenishing the battery using the supplied AC current.

11. The method of claim 1 further comprising:
accepting audio information at the first adapter port; and,
supplying network formatted digital audio information from the second adapter port.

12. The method of claim 1 further comprising:
accepting audio information from the adapter second port; and,
supplying audio information to a mounted speaker connected to the first adapter port.

13. A light bulb adapter camera system comprising:
a housing;
a first data processor having an interface to accept digital image information and an output to supply network formatted digital image information; and,
a light bulb compatible screw base for mounting the camera adapter in a light bulb socket and for accepting AC current.

14. The system of claim 13 further comprising:
a digital camera mounted to the housing, having a lens to accept images and an output connected to the data processor interface to supply digital image information.

15. The system of claim 14 wherein the digital camera is mounted inside the housing; and,
wherein the housing includes an aperture for mounting the camera lens.

16. The system of claim 15 further comprising:
a joint between the housing and the screw base for rotating the housing in a first plane and tilting the first plane with respect to screw base.

17. The system of claim 13 further comprising:
a digital camera having a lens to accept images and an output to supply digital image information; and,
a mounting arm having a first end mounted to the housing and electrically connected to the data processor interface, and a second end mounted to the camera output to accept the digital image information.

18. The system of claim 17 wherein the mounting arm is flexible; and,
wherein the camera lens is pointed in response to flexing the mounting arm.

19. The system of claim 18 wherein the mounting arm second end includes a connector; and,
wherein the digital camera output includes a connector for mating to the mounting arm second end connector.

20. The system of claim 13 wherein the first data processor supplies network formatted digital image information in a wireless communications format; and,
the system further comprising:
a first wireless communications transceiver for transceiving the digital image information.

21. The system of claim 20 further comprising:
a network wireless transceiver having an input to accept the network formatted digital image information from the first wireless communications transceiver and an output to supply the digital image information; and,
a display device connected to the second wireless transceiver to accept and display the digital image information.

22. The system of claim 13 wherein the first data processor is a first powerline modem having an output connected to the screw base to supply digital image information in a powerline networking format.

23. The system of claim 22 further comprising:
a network powerline modem having an input for connection to AC powerlines, to accept the digital image information in the powerline network format, and an output to supply digital image information.

24. The system of claim 23 further comprising:
a display device selected from the group including a video monitor and a personal computer having an input connected to the network powerline modem to accept and display the digital image information.

25. The system of claim 23 wherein the network powerline modem provides the digital image information in a format selected from the group including USB, Ethernet, raster data, or a wireless communications format.

26. The system of claim 13 further comprising:
a microphone having an output connected to the first data processor interface; and,
wherein the first data processor supplies network formatted digital image and audio information.

27. The system of claim 26 further comprising:
an audio speaker having an input connected to the first data processor interface; and,
wherein the first data processor supplies audio information to the speaker.

28. The system of claim 13 wherein the data processor interface has a power input; and,
the system further comprising:
a power converter having an input connected to the screw base to receive AC power and an output to supply converted power to the data processor interface.

29. The system of claim 28 further comprising:
a battery connected to the power converter to supply power and to receive power replenishment.

30. The system of claim 13 further comprising:
a light bulb female socket to accept a light bulb and to supply AC current.

31. A light bulb adapter surveillance system comprising:
a housing;
a camera having an output to supply digital image information;
a microphone having an output to supply audio information;
an audio speaker having an input to accept audio information;
a light bulb compatible screw base for mounting the camera adapter in a light bulb socket and for accepting AC current;
a first data processor having an interface connected to the camera output to receive digital image information, connected to the microphone output to accept audio information, and connected to the speaker input to supply audio information, and an output connected to communicate network formatted digital image and audio information; and,
a light bulb female socket to accept a light bulb and to supply AC current.

32. The system of claim 31 wherein the first data processor is a powerline modem having an output connected to the screw base for supplying digital image information in a powerline network format.
